(19) United States
(12) Patent Application Publication
(10) Pub. No.: US 2023/0113506 A1
(43) Pub. Date: Apr. 13, 2023

(54) SYSTEMS AND METHODS FOR GENERATING CONTENT FOR A USER INTERFACE

(71) Applicant: SHOPIFY INC., Ottawa (CA)

(72) Inventor: Corey POLLOCK, Toronto (CA)

(21) Appl. No.: 17/496,612

(22) Filed: Oct. 7, 2021

(51) Int. Cl. G06Q 30/02; G06F 16/2457

(52) U.S. Cl. CPC G06Q 30/0201; G06F 16/24578

(57) ABSTRACT

Methods and systems are disclosed for generating content for a user interface. For each given online store associated with a customer, a set of data objects associated with the given online store containing displayable content is obtained. One data object is selected to display in a given viewable slot assigned to the given online store. A ranking for a plurality of viewable slots is determined based on slot ranking criteria. Each online store is assigned a defined number of viewable slot(s). The selected data objects for the plurality of viewable slots is provided to an electronic device associated with the customer, to cause the electronic device to display the selected data objects in the plurality of viewable slots in a user interface according to the ranking.

### FIELD

The present disclosure relates to user interfaces, and, more specifically to generating and ranking content displayable in a user interface on a customer's device, including ranking the content based on customer-specific criteria.

### BACKGROUND

Conventionally, when a user elects to receive social media updates from another party (e.g., an individual “friend” or a “followed” company), the updates are commonly provided as notifications in a “feed” that is displayed in a user interface (UI). Generally, the contents of the notifications are created and controlled by the other parties, and the amount of space in the UI that is occupied by notifications from a single party is dependent on how quickly and how much content that party can generate.

### SUMMARY

Existing social media feed formats can present a high barrier to entry for smaller parties or parties who are new to the feed platform. Smaller or newer parties may not be able to compete with larger or more established parties for content generation. Further, smaller or newer parties may not have access to the technical tools needed to create engaging content (or to even identify what would be engaging to users, or to a particular user).

The present application relates to providing a feed in manners such that content from different sources (parties) is balanced. In various examples, systems and methods for generating and provisioning content for a user interface are described.

In some examples, the disclosed systems and methods address a problem with conventional feeds that notifications in the feed can have unbalanced content. For example, if one prolific party has a high rate of content creation, the notifications from that one party can drown out content from other parties in the feed. As well, the competitive nature of content generation results in significant waste of computing resources in processing and communicating an excessive number of notifications.

Furthermore, the disclosed methods and systems may help to ensure fairness in the content displayed to a customer in a user interface, where the user interface includes content associated with online stores. An e-commerce platform that hosts the online stores may act as an intermediary to manage and mediate the content that is to be displayed to the customer in the user interface. In particular, a defined number of viewable slots in the user interface is assigned to each online store that is associated with a customer. Thus, the amount of content in the user interface from any given online store is finite and defined by the e-commerce platform.

In some example aspects, the present disclosure describes a system including a processing unit configured to execute instructions to cause the system to: for each given online store, from a defined plurality of online stores associated with a customer: obtain a set of data objects associated with the given online store containing displayable content; and select one data object, from the set of data objects, to display in a given viewable slot assigned to the given online store. The instructions further cause the system to: determine a ranking for a plurality of viewable slots based on one or more slot ranking criteria including a customer-specific slot ranking criterion, wherein each of the plurality of online stores is assigned a defined number of one or more viewable slots; and provide the selected data objects for the plurality of viewable slots to an electronic device associated with the customer, to cause the electronic device to display the selected data objects in the plurality of viewable slots in a user interface according to the ranking.

In any of the preceding examples, for each given online store, the selected data object may be selected based on a ranking of the set of data objects according to one or more content ranking criteria including a customer-specific content ranking criterion.

In any of the preceding examples, each of the plurality of online stores may be assigned a respective one viewable slot.

In any of the preceding examples, the processing unit may be configured to execute instructions to cause the system to create at least one data object in the set of data objects associated with the given online store by: monitoring operational data associated with the given online store to detect a trigger event; responsive to detecting the trigger event, extracting product data associated with the trigger event; and formatting the product data into displayable content to create a new data object in the set of data objects.

In any of the preceding examples, the trigger event may include one of: addition of a new product page; addition of a new option or a new category associated with existing product data; a defined change in existing product data; a defined change in existing product pricing data; or a defined change in existing product availability data.

In any of the preceding examples, extracting the product data may include: extracting product image data, product description data, product identification data, and product price data. Formatting the product data may include: converting the product image data into a thumbnail format and resolution displayable in the viewable slot; combining the product description data, product identification data and product price data into a set of text data; and storing the converted image data and the set of text data as the displayable content of the new data object.

In any of the preceding examples, the processing unit may be configured to execute instructions to cause the system to access data associated with the given online store via an application programming interface (API) installed with the given online store, where the API may enable monitoring of the operational data and extracting of the product data.

In any of the preceding examples, the one or more content ranking criteria may include at least one of: previous selection of each data object for display in the viewable slot; previous display of each data object in the user interface; recency of each data object; exclusivity of each data object; time-sensitivity of each data object; or an engagement score computed for each data object. The customer-specific content ranking criterion may be one of: an activity relevancy metric computed for each data object with respect to recent online activity associated with the customer; or a characteristic relevancy metric computed for each data object with respect to a characteristic identified from a profile associated with the customer.

In any of the preceding examples, the activity relevancy metric may be computed by: obtaining data representing recent online activity associated with the customer; identifying, from the data, recent online activity associated with a given product; and computing the activity relevancy metric for each data object by computing a correlation between the given product and the displayable content of each respective data object.

In any of the preceding examples, the one or more slot ranking criteria may include at least one of: recency of the respective selected data object for each respective viewable slot; a content engagement score computed for the respective selected data object for each respective viewable slot; or a store engagement score computed for the respective online store assigned to each respective viewable slot. The customer-specific slot ranking criterion may be one of: an activity relevancy metric computed for the respective online store assigned to each respective viewable slot, with respect to recent online activity associated with the customer; or a store relevancy metric computed for the respective online store assigned to each respective viewable slot, with respect to a characteristic identified from a profile associated with the customer.

In any of the preceding examples, the activity relevancy metric may be computed by: obtaining data representing recent online activity associated with the customer; identifying, from the data, recent online activity associated with each respective online store; and computing the activity relevancy metric for each respective online store by computing a weighted sum representing the recent online activity associated with each respective online store, wherein different activity types are weighted by different defined weight values.

In any of the preceding examples, the electronic device may be caused to display the user interface by displaying the plurality of viewable slots in the user device according to the ranking, and by displaying the respective selected data object in each respective viewable slot in the user interface.

In some example aspects, the present disclosure describes a method, including: for each given online store, from a defined plurality of online stores associated with a customer: obtaining a set of data objects associated with the given online store containing displayable content; and selecting one data object, from the set of data objects, to display in a given viewable slot assigned to the given online store. The method also includes: determining a ranking for a plurality of viewable slots based on one or more slot ranking criteria including a customer-specific slot ranking criterion, wherein each of the plurality of online stores is assigned a defined number of one or more viewable slots; and providing the selected data objects for the plurality of viewable slots to an electronic device associated with the customer, to cause the electronic device to display the selected data objects in the plurality of viewable slots in a user interface according to the ranking.

In any of the preceding examples, for each given online store, the selected data object may be selected based on a ranking of the set of data objects according to one or more content ranking criteria including a customer-specific content ranking criterion.

In any of the preceding examples, the method may include creating at least one data object in the set of data objects associated with the given online store by: monitoring operational data associated with the given online store to detect a trigger event; responsive to detecting the trigger event, extracting product data associated with the trigger event; and formatting the product data into displayable content to create a new data object in the set of data objects.

In any of the preceding examples, extracting the product data may include: extracting product image data, product description data, product identification data, and product price data. Formatting the product data may include: converting the product image data into a thumbnail format and resolution displayable in the viewable slot; combining the product description data, product identification data and product price data into a set of text data; and storing the converted image data and the set of text data as the displayable content of the new data object.

In any of the preceding examples, data associated with the given online store may be accessed via an application programming interface (API) installed with the given online store. The API may enable monitoring of the operational data and extracting of the product data.

In any of the preceding examples, the one or more content ranking criteria may include at least one of: previous selection of each data object for display in the viewable slot; previous display of each data object in the user interface; recency of each data object; exclusivity of each data object; time-sensitivity of each data object; or an engagement score computed for each data object. The customer-specific content ranking criterion may be one of: an activity relevancy metric computed for each data object with respect to recent online activity associated with the customer; or a characteristic relevancy metric computed for each data object with respect to a characteristic identified from a profile associated with the customer.

In any of the preceding examples, the one or more slot ranking criteria may include at least one of: recency of the respective selected data object for each respective viewable slot; a content engagement score computed for the respective selected data object for each respective viewable slot; or a store engagement score computed for the respective online store assigned to each respective viewable slot. The customer-specific slot ranking criterion may be one of: an activity relevancy metric computed for the respective online store assigned to each respective viewable slot, with respect to recent online activity associated with the customer; or a store relevancy metric computed for the respective online store assigned to each respective viewable slot, with respect to a characteristic identified from a profile associated with the customer.

In some example aspects, the present disclosure describes a computer readable medium having instructions encoded thereon. The instructions, when executed by a computing system, cause the computing system to: for each given online store, from a defined plurality of online stores associated with a customer: obtain a set of data objects associated with the given online store containing displayable content; and select one data object, from the set of data objects, to display in a given viewable slot assigned to the given online store. The instructions further cause the computing system to: determine a ranking for a plurality of viewable slots based on one or more slot ranking criteria including a customer-specific slot ranking criterion, wherein each of the plurality of online stores is assigned a defined number of one or more viewable slots; and provide the selected data objects for the plurality of viewable slots to an electronic device associated with the customer, to cause the electronic device to display the selected data objects in the plurality of viewable slots in a user interface according to the ranking.

In any of the preceding examples, the computer readable medium may include instructions to implement any of the systems described above.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of an example e-commerce platform, including a UI content generator, in which examples described herein may be implemented;

FIG. 4 illustrates an example UI, which may be provided in accordance with examples of the present disclosure;

FIG. 5 is another block diagram of an example e-commerce platform, showing example details of a UI content generator, in which examples described herein may be implemented;

FIG. 6 is a flowchart illustrating an example method for generating content for a UI, in accordance with examples of the present disclosure; and

FIG. 7 is a flowchart illustrating an example method for creating a data object containing content, which may be used to populate a UI, in accordance with examples of the present disclosure.

Similar reference numerals may have been used in different figures to denote similar components.

### DESCRIPTION OF EXAMPLE EMBODIMENTS

Examples of the present disclosure are described in the context of an e-commerce platform. However, it should be understood that the e-commerce platform described herein is only one possible example and is not intended to be limiting. It should be understood that the present disclosure may be implemented in other contexts, and is not necessarily limited to implementation in an e-commerce platform.

The present disclosure describes example methods and systems for generating content for a user interface (UI), where the UI displays viewable slots containing content from online stores. In particular, each online store is assigned one respective viewable slot, so that content from each online store occupies an equal and fixed amount of space on the UI. Further, the e-commerce platform acts as a trusted third-party that is able to access an online store's operational data (e.g., product pages, pricing data, shipment data, inventory data, etc.) to create new content on behalf of the online store. In this way, the e-commerce platform can automatically generate content to populate the online store's assigned viewable slot in the UI, without the online stores having to compete with each other for content creation.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

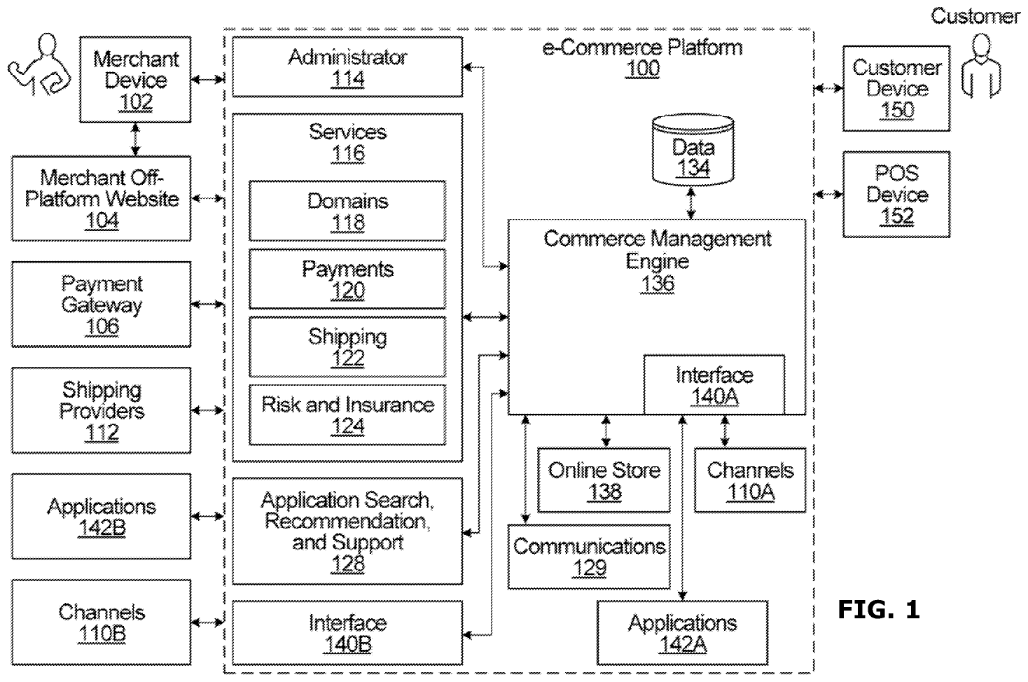

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

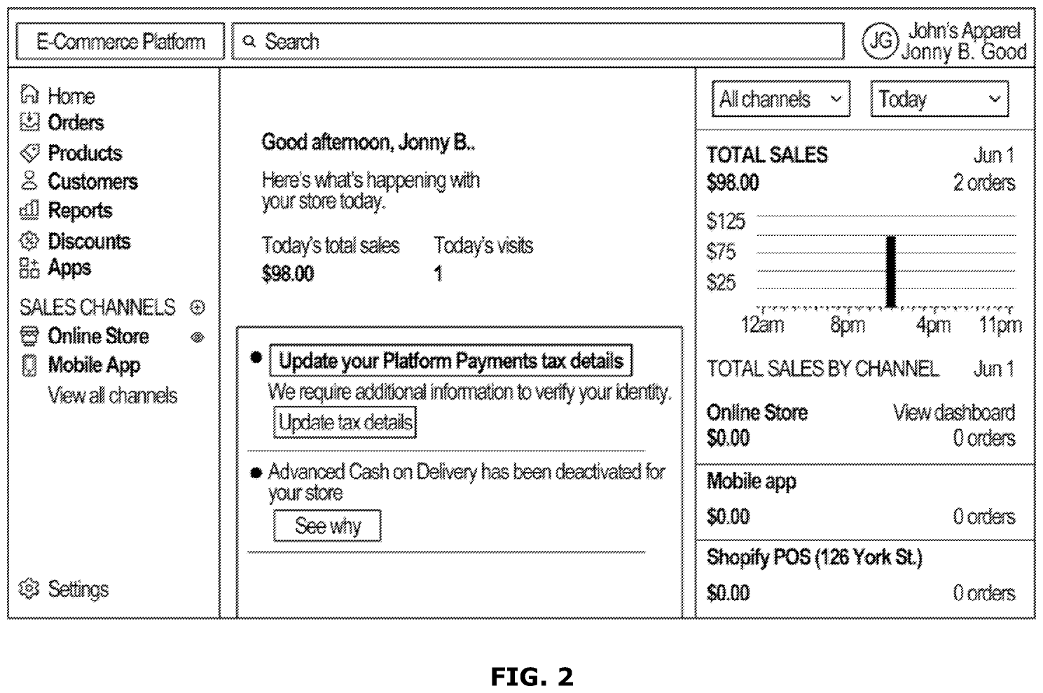

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

Implementation in an e-Commerce Platform

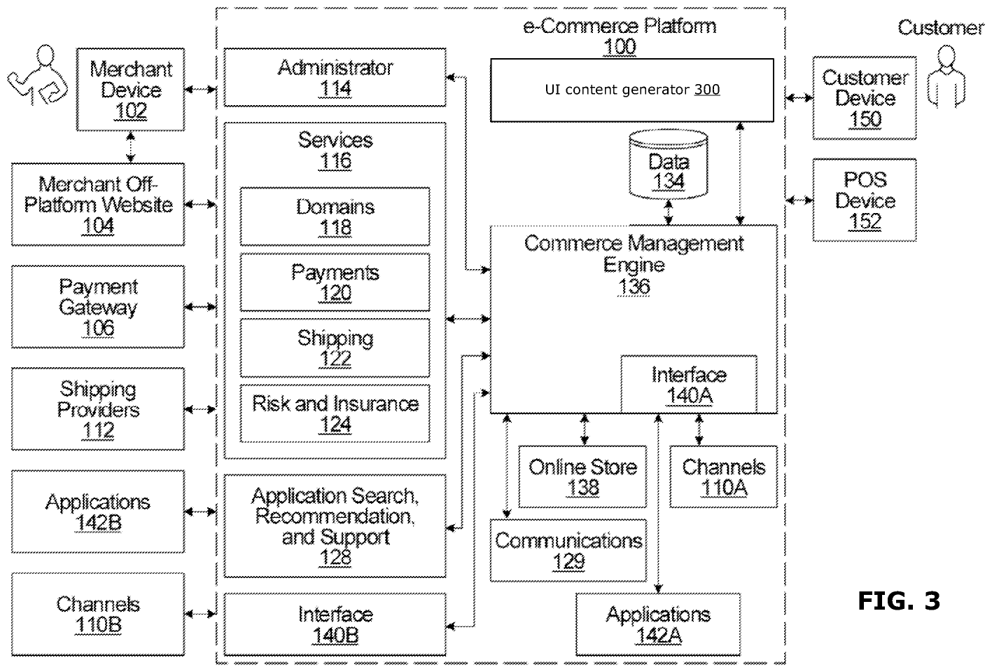

The functionality described herein may be used in commerce to provide improved customer or buyer experiences. The e-commerce platform 100 could implement the functionality for any of a variety of different applications, examples of which are described elsewhere herein. FIG. 3 illustrates the e-commerce platform 100 of FIG. 1 but including a UI content generator 300. The UI content generator 300 is an example of a computer-implemented system that implements the functionality described herein. Further details of the UI content generator are discussed further below.

Although the UI content generator 300 is illustrated as a distinct component of the e-commerce platform 100 in FIG. 3, this is only an example. The UI content generator 300 could also or instead be provided by another component residing within or external to the e-commerce platform 100. In some embodiments, either or both of the applications 142A-B may provide an embodiment of the UI content generator 300 that implements the functionality described herein. The location of the UI content generator 300 may be implementation specific. In some implementations, the UI content generator 300 may be provided at least in part by the e-commerce platform 100, either as a core function of the e-commerce platform 100 or as an application or service supported by or communicating with the e-commerce platform 100. For simplicity, the present disclosure describes the operation of the UI content generator 300 when the UI content generator 300 is implemented in the e-commerce platform 100, however this is not intended to be limiting.

To assist in understanding the present disclosure, an example UI is now discussed. The e-commerce platform 100 may perform functions for populating the example UI with content, for example using the UI content generator 300. It should be understood that the example UI is not intended to be limiting, and other UI configurations may be used within the scope of the present disclosure.

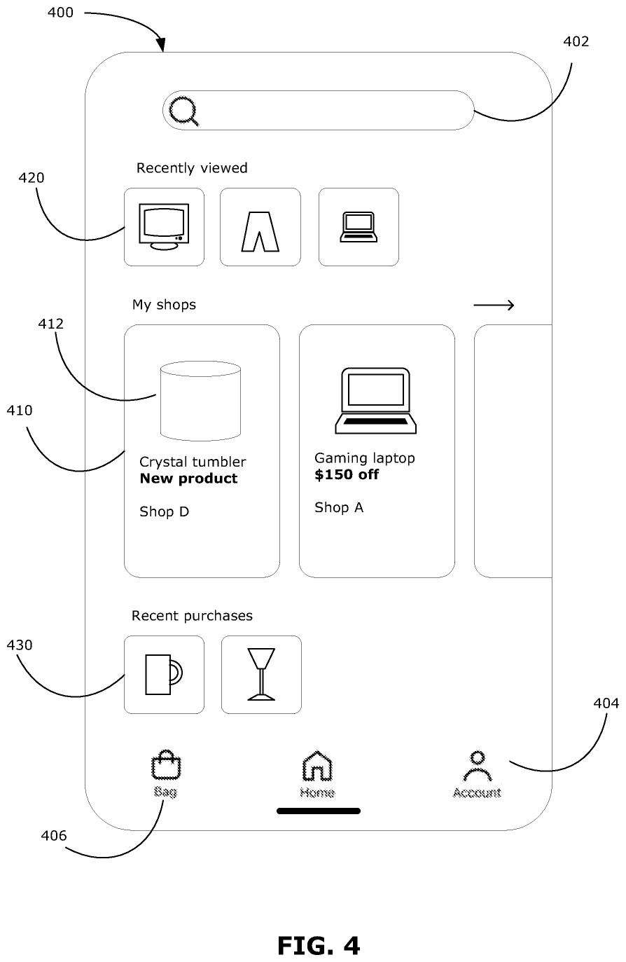

FIG. 4 illustrates an example UI 400, which may be displayed by a customer device 150. A customer device 150 may be any suitable consumer electronic device, such as a laptop device, desktop device, smartphone device, tablet device, etc. The customer device 150 is associated with a customer.

The customer may log into the UI 400 by logging into a customer profile (or account), maintained by the e-commerce platform 100. The customer profile may include information indicating that the customer is associated with one or more online stores 138 hosted by the e-commerce platform 100. For example, the customer profile may indicate that the customer has opted in to receive updates from (or to “follow” or “like”) an online store 138, that the customer has opted in to a distribution list of an online store 138, or that the customer has previously made a purchase with the online store 138. Generally there may be a defined and finite plurality of online stores 138 that are associated with the customer.

The customer may interact with the UI 400 in order to browse product pages of online stores 138, search for products offered by online stores 138, and complete transactions (e.g., purchases) with online stores 138. In particular, the UI 400 displays content that may be/may include content generated by the e-commerce platform 100 (e.g., using the UI content generator 300) and may be pushed or otherwise communicated to the customer device 150 to be displayed.

In this example, the UI 400 includes one or more viewable slots 410, each of which is assigned to a respective one online store 138 that is associated with the customer (e.g., as indicated in the customer profile). Each online store 138 is assigned a respective defined number of viewable slots 410. The defined number of viewable slots 410 that is assigned to each online store 138 is defined by the e-commerce platform 100, and there may be an equal number of viewable slots 410 (e.g., one viewable slot 410) assigned to each online store 138. Having an equal, defined number of viewable slots 410 assigned to each online store 138 may help to ensure fairness among the online stores 138, and may help to more evenly distribute the amount of computing resources (e.g., processing resources, memory resources) used to display content across the online stores 138. The viewable slots 410 may be scrollable, so that not all viewable slots 410 are displayed in the UI 400 at the same time. It may be noted that, because the number of online stores 138 associated with the customer is defined and finite, and because the number of viewable slots 410 assigned to each online store 138 is also defined and finite, the number of viewable slots 410 in the UI 400 is also defined and finite.

Each viewable slot 410 displays content 412 associated with the respective online store 138. In particular, the content 412 of each viewable slot 410 may be contained in a respective data object, which is provided by the e-commerce platform 100 (e.g., using the UI content generator 300). Further details about the operations of the e-commerce platform 100 to provide the data objects will be discussed later.

The UI 400 may also display images and/or text representing recently viewed items 420 (e.g., images from recently viewed product pages), as well as images and/or text representing recently completed transactions 430 (e.g., images of recently purchased products). Any or all of the content in the viewable slots 410, recently viewed items 420 and/or recently completed transactions 430 may be selectable by the customer, in order to navigate to another page in the UI 400 that may provide more information about the selected content.

The UI 400 may also include other input options such as a search field 402 (e.g., for inputting a search query), a selectable account option 404 (e.g., for accessing a page containing information from the customer profile), or a selectable bag option 406 (e.g., for accessing a page containing information about the customer's completed and/or incomplete transactions).

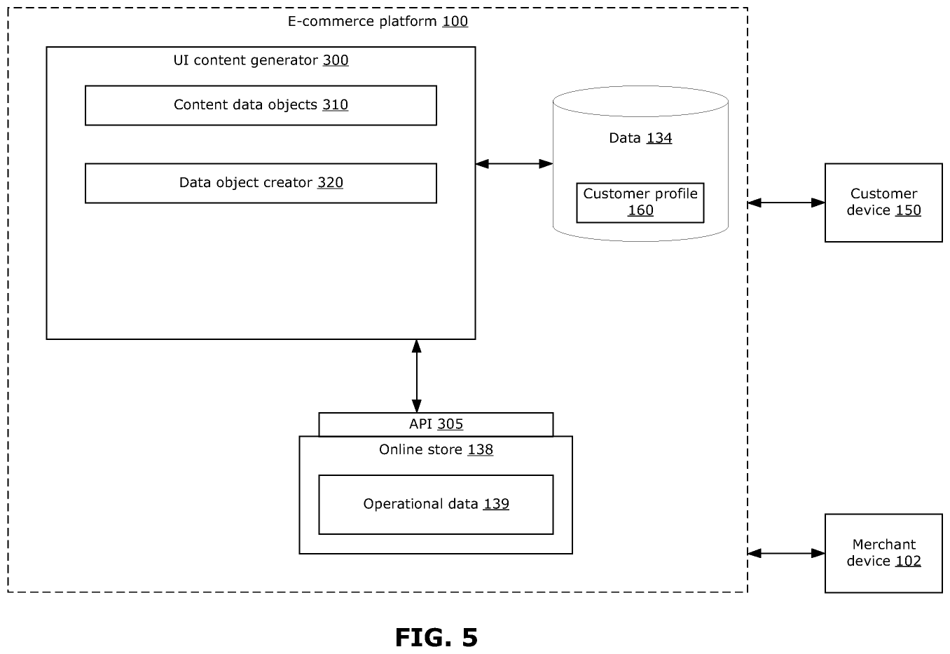

Reference is now made to FIG. 5, which is a block diagram showing further details of the UI content generator 300 in the context of the e-commerce platform 100. Some details of the e-commerce platform 100 are not shown, to avoid clutter. FIG. 5 illustrates other computing systems interacting with the e-commerce platform 100, including the merchant device 102 and the customer device 150.

The UI content generator 300 performs operations to generate content for populating a UI, such as the example UI 400 of FIG. 4. In some examples, the UI may be also generated by the UI content generator 300 and provided to the customer device 150 to be rendered for display. In other examples, the UI may be generated by an application 142A-B (not shown in FIG. 5) that uses the content from the UI content generator 300 to generate the UI to be rendered for display by the customer device 150. In other examples, the UI may be generated by an application (not shown) resident on the customer device 150, using content provided by the UI content generator 300.

In the example shown, the UI content generator 300 may communicate with the data facility 134 to access one or more customer profiles 160 stored in the data facility 134, where each customer profile 160 is associated with a respective customer (including a customer who is also associated with a respective customer device 150). A customer may, for example, log into the e-commerce platform 100 or log into an application 142A-B that facilitates access to the e-commerce platform 100 (e.g., log into a shopping application) via the customer device 150 (e.g., during a communication session between the e-commerce platform 100 and the customer device 150). The customer's login information (e.g., username and password) may be used to authenticate the customer and associate the respective customer profile 160 with the communication session between the e-commerce platform 100 and the customer device 150. In this way, the customer may interact with the e-commerce platform 100 via the customer device 150, including searching product pages of online stores 138, completing transactions with online stores 138, updating a customer profile 160, etc. As well, the e-commerce platform 100 may identify the correct customer profile 160 corresponding to the customer associated with the customer device 150, and may enable the UI content generator 300 to generate content that is tailored to the particular customer (e.g., based on data contained in the corresponding customer profile 160).

The customer profile 160 may include data indicating one or more online stores 138 associated with the customer, for example data identifying an online store 138 from which the customer has opted in to receive updates (or to “follow” or “like”), data identifying an online store 138 for which the customer has opted in to a distribution list, and/or data identifying an online store 138 with which the customer has previously made a purchase. For example, responsive to the customer selecting an option (e.g., presented via the customer device 150) to opt in to receive updates from (or to “follow” or “like”) an online store 138, the e-commerce platform 100 may automatically update the corresponding customer profile 160 to include data identifying the online store 138 as one of the online stores 138 associated with the customer. The customer profile 160 may further indicate the type of the association with the customer and/or the strength of the association. For example, the customer profile may indicate if the association is an explicit opt-in, “follow” or “like”, which may be considered a strong association; or may indicate if the association is a weak association such as the customer having browsed the product pages of the online store 138.

The customer profile 160 may also include data about the customer's online activity, including online searches, online browsing (e.g., product pages viewed by the customer), etc. The data about the customer's online activity may include data about the customer's transactions, for example data identifying a product the customer has purchased, exchanged or returned (and optionally the online store 138 associated with that product). The customer profile 160 may also include data about the customer's characteristics and/or preferences, such as the customer's address, personal information (e.g., age, gender, marital status, etc.), product categories of interest (e.g., sports, computers, etc.), and so forth. Characteristics of the customer may be properties that are descriptive of the customer as a person, and may be distinct from the customer's online activity. However, the customer's online activity may be analyzed to identify likely characteristics of the customer. For example, if the customer's online activity indicates the customer frequently searches for sports equipment, then sports may be identified as a product category of interest for the customer.

The UI content generator 300 also communicates with one or more online stores 138, for example via an API 305. For example, a merchant who wishes to use the UI content generator 300 to provide content to a customer via a UI (e.g., the UI 400) may install the API 305 (e.g., installed from an application repository, such as an app store) with the merchant's online store 138. Installation of the API 305 with the online store 138 enables the UI content generator 300 to access operational data 139 associated with the online store 138. By installing the API 305, the merchant may explicitly or implicitly give the UI content generator 300 content to access the operational data 138 and further to automatically create content for the online store 138 using the operation data 138, possibly without requiring additional input or consent from the merchant. Operational data 139 associated with the online store 138 may include product pages, product pricing data, product inventory data, shipment data, sales data, customer distribution lists, advertising data, subscription data, etc.

The UI content generator 300 stores and maintains content data objects 310. The content data objects 310 each contains displayable content data that may be used for populating a UI. For example, each viewable slot 410 in the example UI 400 may be populated using content 412 from a respective content data object 310. The content data in a content data object 310 may include text data and/or image data that can be displayed as content 412 in a viewable slot 410. Each content data object 310 may also include unique identification data (e.g., a data object identifier (ID)), which may be used to identify or reference the content data object 310. Each content data object 310 may also include data associating the content data object 310 with a respective online store 138 and/or with a respective product (e.g., the content data object 310 may include a store and/or product identifier). In particular, the UI content generator 300 may store and maintain a set of content data objects 310 associated with a respective online store 138 (e.g., there may be a set of content data objects 310 associated with each online store 138 having the API 305).

The UI content generator 300 also includes a data object creator 320, which creates new content data objects 310. The data object creator 320 may monitor the operational data 139 of a given online store 138 (e.g., via the API 305) to detect a trigger event for creating new content for the online store 138. For example, a trigger event may be addition of a new product page, addition of a new option or new category (e.g., new color variant, new size, new subscription option, new bundle option, etc.) associated with data for an existing product. A trigger event may be a change in the operational data 139 that meets or exceeds a defined change threshold and/or that satisfies a defined change rule. The defined change threshold and/or defined change rule may help to ensure that the trigger event is significant enough to warrant creation of a new content data object 310 related to the trigger event. For example, a price change of only 1% might not be significant and a defined price percentage threshold might not be satisfied, thus computing resources (e.g., processing power and memory resource) need not be consumed to create a content data object 310 related to this minor price change. Examples of changes that satisfy a defined change threshold and/or defined change rule (and thus are considered to be trigger events) may include: a change in existing product pricing data that exceeds a dollar threshold (e.g., greater than $10 change in price) or a percentage threshold (e.g., greater than 10% change in price), a defined change in existing product availability data that satisfies a change rule (e.g., inventory data previously indicated a product was out of stock and has been updated to indicate the product is back in stock) or that exceeds a change threshold (e.g., inventory data indicates the product availability has increased or decreased by over 50%, or indicates that the product availability is down to 100 units or fewer), or a defined change in existing product data that that satisfies a change rule (e.g., critical data such as safety data has changed), among other possibilities. In general, the data object creator 320 may parse the operational data 139 of the online store 138 in accordance with defined parsing rules (e.g., based on known data fields in the operational data 139, and by comparing a current state of the operational data 139 to a previous state) to determine whether a change in the operational data 139 is a trigger event.

After the trigger event is detected, the data object creator 320 may extract operational data 139 associated with the trigger event, via the API. The data object creator 320 may identify a product associated with the trigger event (e.g., the product associated with the detected new product page, the product associated with the change in pricing data, the product associated with the change in availability data, etc.) and extract the corresponding product data from the operational data 139 of the online store 138. The extracted product data may include product image data, product description data, product identification data and/or product price data. The data object creator 320 may then format the extracted product data into displayable content and store the content in a newly created content data object 310. The newly created content data object 310 may then be included in the set of content data objects 310 that is associated with the online store 138.

Formatting the extracted product data may include, for example, converting the product image data into a thumbnail format and resolution suitable for display in the viewable slot 410 of the UI 400. Formatting the extracted product data may also include generating a combined set of text data from the product description data, product identification data and/or product price data, where the text data is suitable in length (e.g., defined number of characters) and size (e.g., font size and font type) to be displayed in the viewable slot 410. An identifier of the online store 138 (e.g., a name of the online store 138) may also be included in the text data. In some examples, a description related to the trigger event may also be included in the text data to be displayed in the viewable slot 410. For example, if the trigger event is new product data, the data object creator 320 may automatically generate and insert a text string “New Product” in the text data; in another example, if the trigger event is a change in pricing data, the data object creator 320 may automatically parse the pricing data to determine the amount of change (e.g., $50 decrease in price), then generate and insert a text string “$50 off” in the text data. In general, the data object creator 320 may use defined rules to automatically generate and insert a text string according to the type of trigger event detected.

In this way, the data object creator 320 may automatically create new content data objects 310 for an online store 138, without requiring input from a merchant. It should be noted that creation of new content data objects 310 in this manner may involve the UI content generator 300 to directly accessing the operational data 139 of the online store 138, without any human intervention, and may involve computer-based communication of data between the UI content generator 300 and the online store 138 in a manner that cannot be replicated by a human.

Using the UI content generator 300, the e-commerce platform 100 maintains and creates content associated with online stores 138, and manages how such content is provided to the customer via a UI displayed on the customer device 150. In particular, the UI content generator 300 provides content data objects 310 to be displayed on the customer device 150 in a way that ensures the displayed content is associated with only online stores 138 having an established association with the customer (e.g., the customer has opted in to notifications from the online stores 138), and that ensures a defined size of footprint in the UI (e.g., defined number of viewable slots 410) for each online store 138. This helps to ensure fairness in the UI's content, and helps to address the problem of unbalanced UI content found in conventional feeds.

The UI content generator 300 also performs operations to manage the content 412 that is displayed in each viewable slot 410 in a way that is tailored to the customer. For example, the UI content generator 300 may select and/or rank content data objects 310 associated with a given online store 138, and provide the selected or highest ranked content data object 310 to populate the viewable slot 410 assigned to the given online store 138, where the selection or ranking is based on customer-specific ranking criteria (as discussed further below). The UI content generator 300 may also perform operations to refresh or re-rank the content 412 in a given viewable slot 410 so that the content 412 appears fresh to the customer each time (e.g., each time the customer opens the UI 400 or each time the given viewable slot 410 is scrolled into view in the UI 400), even if there actually has not been any new content data object 310 created for the online store 138 assigned to the given viewable slot 410.

As described above, the content data objects 310 associated with a given online store 138 may include content data objects 310 that are automatically created by the UI content generator 300 (e.g., using data extracted from the operational data 139 of the given online store 138). This means that a merchant does not need to compete with other merchants for content creation. Further, the content data objects 310 (and by extension the content displayed in the UI 400) may not contain content that is insignificant and/or redundant, such as content created merely to artificially amplify the presence of an online store 138 in the UI content. Thus, the unnecessary consumption of computing resources (e.g., processing power and memory resources devoted to such insignificant content) may be reduced.

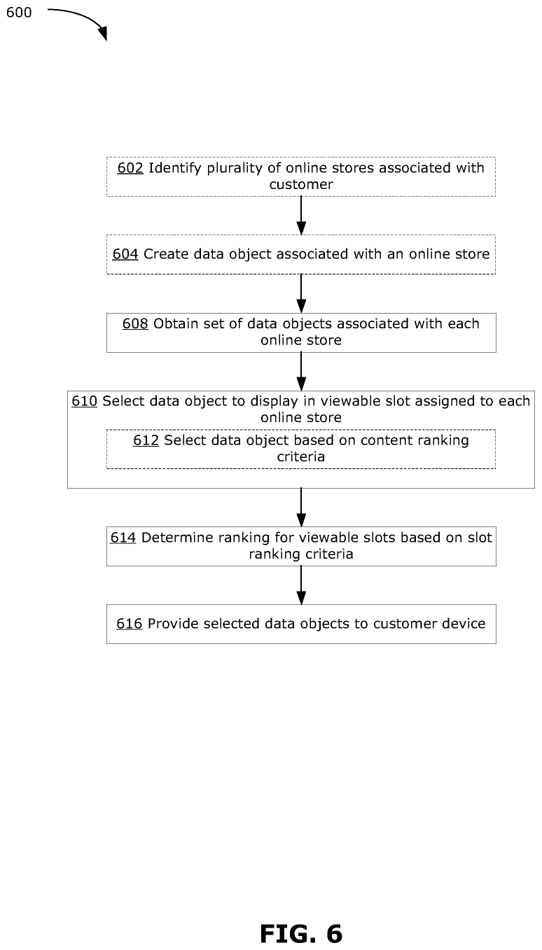

FIG. 6 is a flowchart illustrating an example method 600 that may be performed by the e-commerce platform 100, for example using the UI content generator 300. For example, a computing system (e.g., a server, or a server cluster) having a processing unit implementing the e-commerce platform 100 (including the UI content generator 300) may execute computer-readable instructions to perform the method 600.

The method 600 may be performed whenever content needs to be generated to populate the viewable slots 410 of the UI 400. For example, the method 600 may be performed whenever a customer opens the UI 400 on the customer device 150.

Optionally, at an operation 602, the UI content generator 300 may identify a plurality of online stores 138 that are associated with a customer. As previously mentioned, the customer profile 160 associated with a customer may be identified using login information provided by the customer (e.g., via the customer device 150). The online stores 138 that are associated with the customer may be identified using data from the customer profile 160, as discussed above. In some examples, the online stores 138 that are associated with the customer may be identified based on the online stores 138 that the customer has explicitly opted in or signed up for updates (which may be considered strong associations), and may not include the online stores 138 that the customer may have a weaker association with (e.g., online stores 138 where the customer has searched or browsed for products, but without making a purchase). In some examples, the customer profile 160 may identify the online stores 138 that the customer has explicitly selected to “like” or “follow” (or otherwise receive updates from), and these are the online stores 138 that may be identified at the operation 602.

In some examples, the operation 602 may be omitted from the method 600. For example, instead of the UI content generator 300 identifying the online stores 138 that are associated with the customer, the plurality of online stores 138 that the customer is associated with may be instead defined by an application. For example, the customer may interact with an application on the customer device 150 to indicate the online stores 138 of interest, and the identifiers of these online stores 138 may be provided to the UI content generator 300 as the online stores 138 associated with the customer.

Optionally, at an operation 604, the UI content generator 300 may perform operations to create a content data object 310 (or more simply data object 310) for a given online store 138 (which may be one of the online stores 138 associated with the customer). The UI content generator 300 may (using the data object creator 320) perform operations as discussed above for creating a new data object 310 containing new content for the given online store 138.

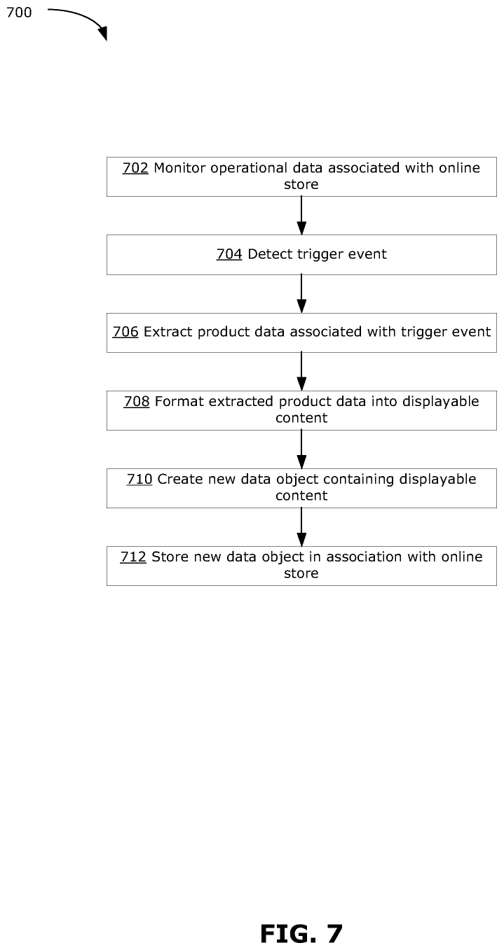

FIG. 7 is a flowchart illustrating an example method 700 that may be performed by the e-commerce platform 100 (e.g., using the UI content generator 300) in order to carry out the operation 604.

At an operation 702, the UI content generator 300 monitors operational data 139 associated with a given online store 138 to detect a trigger event (e.g., via the API 305 installed with the given online store 138).

At an operation 704, a trigger event is detected from the operational data 139. As previously discussed, the trigger event may be a change in the operational data 139 that satisfies a defined threshold or a defined change rule. For example, the trigger event may include: addition of a new product page, addition of a new option or new category (e.g., new color variant, new size, new subscription option, new bundle option, etc.) associated with data for an existing product, a defined change in existing product data, a defined change in existing product pricing data, or a defined change in existing product availability data, among other possibilities. Other possible trigger events that may be detected include: addition of new marketing data (e.g., new discount data, new marketing campaign data, new flash-sale data), existing product data being flagged as a featured product, existing product data being grouped together as a new collection, new relationship data between existing products (e.g., new recommendations based on pairing of existing products), etc. It should be understood that other trigger events may be detected from the operational data 139.

At an operation 706, after the trigger event has been detected, product data associated with the trigger event is extracted (e.g., via the API 305). The extracted product data may include product image data, product description data, product identification data and/or product price data for a product that is associated with the trigger event. The product that is associated with the trigger event may be identified from the trigger event itself (e.g., by identifying the product associated with a new product page, associated with the detected change in pricing data, associated with the detected change in availability data, etc.).

At an operation 708, the extracted product data is formatted into displayable content. For example, if the extracted product data includes image data, the image data may be formatted into a thumbnail format and a resolution suitable for display in the viewable slot 410. If the extracted product data includes different text data (e.g., product description data, product identification data and/or product price data), these data may be combined into text data suitable for display in the viewable slot 410. A text descriptor of the trigger event and/or a text identifier of the given online store 138 may also be added to the text data.

At an operation 710, a new data object 310 is created to contain the new displayable content (e.g., the formatted image and/or text data). The new data object 310 may contain other data, such as a data object identifier, a store identifier (e.g., identifying the given online store 138), a product identifier (e.g., identifying the product associated with the displayable content), etc.

At an operation 712, the new data object 310 is included and stored in the set of data objects 310 associated with the given online store 138, which may be used to populate the viewable slot 410 assigned to the given online store 138.

It should be noted that the method 700 may also be performed as a part of the method 600 (e.g., performed in real-time when content is needed to populate the UI 400) as well as outside of the method 600. For example, the UI content generator 300 may continuously, intermittently or regularly (e.g., on a daily or hourly basis) monitor the operational data 139 of the online store 138 (e.g., any time after the API 305 has been installed with the online store 138) in order to detect any trigger event and create a new data object 310 with new content. In this way, the UI content generator 300 may enable automatic creation of data objects 310 containing automatically extracted content from the online store 138, any time throughout normal operation of the online store 138. Because the e-commerce platform 100 hosts the online store 138, the e-commerce platform 100 has access to the operational data 139 of the online store 138 (e.g., via the API 305). Thus, the e-commerce platform 100 is able to directly monitor the operational data 139 of the online store 138 to create new content to populate the viewable slot 410 on behalf of the online store 138, without requiring the active involvement of the merchant or owner of the online store 138. This may be useful particularly in the case of smaller or newer online stores 138 that may not otherwise have the knowledge or technical tools needed to create appropriate content to populate the UI 400.

The e-commerce platform 100 can create many data objects 310 for a given online store 138 using the method 700. This may provide a set of data objects 310 with rich and varied content from which a data object 310 may be selected to populate the viewable slot 410 assigned to the given online store 138. This automatic creation of data objects 310 may enable creation of a set of data objects 310 with more varied content than would be possible manually, which in turn may help to enable more customer-oriented content to be provided via the UI 400. Notably, the creation of data objects 310 with new content may not be directly controlled by the merchant or owner of the online store 138. This may help to ensure that the data objects 310 associated with an online store 138 contains content that is an accurate reflection of efforts to engage customers via product offerings, rather than just insignificant or redundant content generation (which may result in unnecessary consumption of computing resources, without any benefit to the customer).

Reference is again made to FIG. 6.

At an operation 608, for each online store 138 that is associated with the customer, a respective set of data objects 310 is obtained. For example the UI content generator 300 may identify, from its stored data objects 310, the set of data objects 310 for each online store 138 using a store identifier included in each data object 310.

At an operation 610, for each given online store 138 associated with the customer, one data object 310 is selected from the respective set of data objects 310 to display in the viewable slot 410 assigned to the given online store 138. Notably, the operation 610 enables the e-commerce platform 100 to manage the content that is displayed in the viewable slot 410 assigned to each online store 138 (rather than being directly controlled by the online store 138 or being directly controlled by content generation). Performing the operation 610 may include optionally performing the operation 612.

At an optional operation 612, the data object 310 that is selected for a given online store 138 may be selected based on one or more content ranking criteria. The content ranking criteria may include customer-specific content ranking criteria, which ranks each of the data objects 310 with respect to certain customer-specific considerations, as well as non-customer-specific (or general) content ranking criteria.

Example content ranking criteria may include: whether a given data object 310 was previously selected for the online store 138, which may be quantified based on the amount of time since the data object 310 was previously selected (such that a more recently selected data object 310 may have a lower score); whether a given data object 310 was previously displayed in the UI 400 (e.g., the UI 400 may communicate to the UI content generator 300 whether the given data object 310 was actually displayed or scrolled to in the UI 400), which may be quantified based on the amount of time since the data object 310 was previously displayed (such that a more recently displayed data object 310 may have a lower score); based on how recent the data object 310 was created, which may be quantified based on a timestamp (which may be included in the data object 310) associated with the creation of the data object 310 (such that a more recently created data object 310 may have a higher score); based on overall customer engagement, which may be quantified by tracking click rate for each data object 310 and computing an engagement score for each data object 310 (such that a data object 310 having a higher click rate has a higher score); based on the exclusivity of the data object 310, which may be quantified based on the scarcity of products (e.g., the data object 310 is associated with a product having a finite number of available units) (such that a data object 310 that is more exclusive has a higher score); based on the time-sensitivity of the data object 310, which may be quantified based on an expiry date of the content (e.g., the data object 310 contains time-sensitive content such as content about a flash-sale) (such that a data object 310 that is more time-sensitive has a higher score); whether the data object 310 contains content related to recent online activity associated with the customer, which may be quantified by an activity relevancy metric (described further below); or whether the data object 310 contains content related to a characteristic associated with the customer (e.g., as identified from the customer profile 160), which may be quantified by a characteristic relevancy metric (described further below).

The activity relevancy metric may be computed by obtaining data representing the customer's recent online activity, and identifying a given product associated with the online activity (e.g., the product in a recent purchase or the product in a recent search query). The activity relevancy metric may then be computed by computing a correlation between the product associated with the online activity and the content of the data object 310 (e.g., by computing a correlation between a vector representing characteristics of the product associated with the online activity, and another vector representing characteristics of a product associated with the content of the data object 310). Content that is related to, similar to or complementary to the product associated with recent online activity may be scored higher.

The characteristic relevancy metric may be computed by querying data in the customer profile 160, which may be further analyzed (e.g., statistically, or using machine learning algorithms to extract features) to identify characteristics of the customer. For example, data in the customer profile 160 may be used to identify a customer's demographic (e.g., age, gender, etc.), purchasing habits (e.g., habitual purchases, product categories of interest, frequency of purchasing certain products, etc.) and/or shopper type (e.g., frequently purchases high-priced products, frequently purchases discounted products, frequently purchases newly-launched products, etc.). The characteristic relevancy metric may be computed by computing a correlation between the characteristics of the customer and the content of the data object 310. For example, the product associated with the content of the data object 310 may be associated with certain customer characteristics (e.g., based on customers who have purchased the product in the past). A correlation may be computed between a vector representing the customer characteristics associated with the product and a vector representing the characteristics of the customer. Content that is more correlated with the characteristics of the customer may be scored higher.

In some examples, a content ranking metric may be computed to enable a plurality of content ranking criteria to be considered together. For example, a points-based scoring system may be used where a score is determined for each data object 310 according to each criterion (e.g., based on the quantification described above) and then a total score is used to rank the data objects 310. In some examples, in addition to the quantification or scoring of each criterion, a weight may be applied based on the defined relative importance of each criterion (e.g., customer-specific criteria may in general be weighted more heavily than non-customer-specific criteria) and the ranking may be based on the weighted total score. Other methods for computing a content ranking metric may be used.

Notably, the operation 612 may result in a data object 310 containing older content being selected to be displayed if that data object 310 is, for example, the most relevant to the customer's recent online activity.

The ranking of the data objects 310 may be updated whenever the UI 400 needs to be populated with content, whenever the viewable slots 410 are scrolled, whenever there are any new data objects 310 for an online store 138 associated with the customer, or at regular intervals, for example.

Regardless of whether optional operation 612 is performed, after the operation 610 is performed the method 600 proceeds to the operation 614.

At the operation 614, the plurality of viewable slots 410 assigned to the online stores 138 are ranked, based on one or more slot ranking criteria. As previously described, there is a defined, finite number of viewable slot(s) 410 assigned to each online store 138, for example there may be one viewable slot 410 assigned to each online store 138 associated with the customer. This may help to avoid the problem of unbalanced content being displayed in the UI 400.

The slot ranking criteria may include customer-specific slot ranking criteria, which ranks each of the viewable slots 410 with respect to certain customer-specific considerations, as well as non-customer-specific (or general) slot ranking criteria.

Example slot ranking criteria may include: whether the customer has recently interacted with the assigned online store 138, which may be quantified based on the amount of time since the last customer interaction (e.g., purchase, viewing a product page, etc.) with the online store 138 (such that a viewable slot 410 assigned to an online store 138 with a more recent interaction with the customer has a higher score); the ranking of the data object 310 that was selected for the viewable slot 410, which may be quantified by using the score computed for the data object 310 as the score for the viewable slot 410; the recency of the selected data object 310 for the viewable slot 410, which may be quantified based on the timestamp of the data object 310 as described above; a content engagement score computed for the selected data object 310 for the viewable slot 410, which may be quantified based on click rate as described above; a store engagement score computed for the online store 138 assigned to the viewable slot 410; an activity relevancy metric computed for the online store 138 assigned to the viewable slot 410, with respect to recent online activity associated with the customer (described further below); or a store relevancy metric computed for the online store 138 assigned to the viewable slot 410, with respect to a characteristic identified from the customer profile 160 (described further below). Other factors that may be taken into account for determining the slot ranking may include a predicted customer-specific engagement with a given viewable slot 410, which may be dependent on the data object 310 selected for the given viewable slot 410. For example, if the selected data object 310 for a given viewable slot 410 has a higher characteristic relevancy metric than another data object 310 selected for another viewable slot 410, then the given viewable slot 410 may be ranked higher. In this way, the ranking of the viewable slots 410 may differ among two different customers, even if the two customers are associated with the same online stores 138.

When quantifying the customer's recent interaction with the online store 138 assigned to a given viewable slot 410, a weighting may be applied to the type of interaction. For example, the type of interaction that the customer has had with the online store 138 may be determined from data about the customer's recent online activity. An interaction that is a purchase of a product may be given the highest weight, followed by an interaction that is placing a product in a virtual cart (without a purchase), followed by clicking previous content displayed in the viewable slot 410 for the online store 138, followed by viewing a product page of the online store 138 at the lowest weight.

The activity relevancy metric used for determining ranking of the viewable slots 410 may be computed similarly to that described above for ranking the data objects 310. Data representing the customer's recent online activity may be obtained, to identify an online store 138 associated with the online activity and the interaction type. Then the amount and/or recency of the activity may be weighted by the defined weight for the interaction type (e.g., as described above) and a weighted sum computed for each online store 138. The activity relevancy metric for each viewable slot 410 may then be the weighted sum that was computed for the respective online store 138 assigned to each viewable slot 410.

The store relevancy metric may be computed by identifying characteristics of the customer (e.g., using data in the customer profile 160, as described above), and correlating the online store 138 with the characteristics of the customer. For example, if the online store 138 is associated with a product category that is also a preference of the customer (e.g., as indicated in the customer profile 160), then the online store 138 has a strong correlation with the customer and thus a high store relevancy metric. In another example, the online store 138 may be associated with certain customer characteristics (e.g., based on the demographics or other characteristics of customers who have made purchases with the online store 138). A correlation between the customer characteristics associated with the online store 138 and the characteristics of the customer may be computed (e.g., using vector correlation as described above), to determine the store relevancy metric.

In some examples, a slot ranking metric may be computed to enable a plurality of slot ranking criteria to be considered together. For example, a points-based scoring system may be used (similar to that described above), and optionally a weight may be applied based on the defined relative importance of each criterion (e.g., customer-specific criteria may in general be weighted more heavily than non-customer-specific criteria).

It may be noted that, an online store 138 cannot directly affect the ranking of its assigned viewable slot 410 simply by generating more content. Rather, the e-commerce platform 100 manages ranking of the viewable slots 410 according to various criteria including customer-specific criteria.

At an operation 616, after a respective data object 310 has been selected to populate each viewable slot 410 and the viewable slots 410 have been ranked, the selected data objects 310 are provided to be displayed by the customer device 150. For example, the data objects 310 selected for the viewable slots 410 may be provided to the customer device 150 in an order according to the ranking of the viewable slots 410, to enable an application resident on the customer device 150 to display the UI including the viewable slots 410 that are populated with the respective selected data object 310. The ranking of the viewable slots 410 may be implicit (e.g., according to the order that the data objects 310 were sent to the customer device 150). In some examples, the ranking of the viewable slots 410 may also be explicitly provided to the customer device 150, to enable the viewable slots 410 to be ranked according to the determined ranking.

In some examples, the selected data objects 310 (and optionally the determined ranking of the viewable slots 410) may be provided to an application 142A resident on the e-commerce platform 100 to populate the viewable slots 410 of the UI 400. The populated UI 400 may then be accessed by the customer device 150 (e.g., using a web browser or other viewing application).

Reference is again made to FIG. 4. The example UI 400 illustrates an example of how the UI content generator 300 provides content to populate the viewable slots 410 of the UI 400, for example in accordance with the method 600.

In this example, the UI 400 is displayed on a customer device 150 associated with a customer. The UI 400 may display images and/or text representing recently viewed items 420 and images and/or text representing recently completed transactions 430 (e.g., identified from tracking the online activity of the customer and/or from data stored in the customer profile 160 associated with the customer). The UI content generator 300 has identified at least Shop D and Shop A as online stores 138 associated with the customer and thus the UI 400 includes viewable slots 410 assigned to Shop D and Shop A. Other online stores 138 may have also been identified as being associated with the customer, and their respective viewable slots 410 may be currently not displayed but may be scrolled to (e.g., by the customer using a swiping gesture on the UI 400).

The UI content generator 300 has selected a particular data object 310 to populate the viewable slot 410 assigned to Shop D (e.g., based on ranking a set of data objects 310 associated with Shop D), specifically a data object containing content 412 associated with a crystal tumbler product. The UI content generator 300 (e.g., using the data object creator 320) may have created the data object 310 with the content 412 associated with the crystal tumbler using the method 700. For example, a trigger event may have been detection of new product data from the operational data 139 of Shop D. The image data and text data associated with the new product may be extracted from the operational data 139 and formatted to create content (e.g., an image of the crystal tumbler; text describing the crystal tumbler, that it is a new product and that the product is from Shop D) for the data object 310. Similarly, the UI content generator 300 has selected another data object 310 to populate the viewable slot 410 assigned to Shop A.

The viewable slots 410 are also ranked by the UI content generator 300 and are displayed in the UI 400 according to their ranking. In this example, because the customer has recently made purchases from Shop D (e.g., has purchased other drinkware recently), the viewable slot 410 assigned to Shop D is ranked the highest (e.g., Shop D scores the highest in the slot ranking criteria). Further, because the customer has recently viewed product pages related to products associated with Shop A (e.g., has viewed product pages for other computing devices, which is a category of product that is associated with Shop A), the viewable slot 410 assigned to Shop A is ranked the second highest in this example.

Notably, regardless of how strong the relationship is between the customer and Shop D or Shop A, and regardless of the amount of content in the data objects 310 associated with each online store 138, the number of viewable slots 410 assigned to each of the online stores 138 is fixed and finite (in this example, only one viewable slot 410 is assigned to each online store 138). This may help to ensure that the content displayed in the UI 400 is balanced and fair among the different sources (in this case, balanced amount the online stores 138) associated with the content.

In some examples, the e-commerce platform 100 (e.g., via the UI content generator 300) may assign different numbers of viewable slots 410 to different online stores 138, according to one or more eligibility criteria. For example, an online store 138 may need to satisfy a first set of eligibility criteria (e.g., being operational on the e-commerce platform 100 for a minimum amount of time such as three months, having a minimum amount of sales, having a charge-back rate that is below a threshold, being configured with financial information, having the API 305 installed, etc.) in order to have one assigned viewable slot 410. Any online store 138 that does not satisfy the first set of eligibility criteria may not have any assigned viewable slot 410 in the UI 400. An online store 138 that satisfies a second set of eligibility criteria (e.g., being operational on the e-commerce platform 100 for at least two years, having over 100 different products, having a minimum number of customers opting in to receive updates, etc.) may be assigned two viewable slots 410. Other such techniques may be used by the e-commerce platform 100 to control and manage the number of viewable slots 410 displayed to a customer in the UI 400. In this way, the e-commerce platform 100 may serve to manage and mediate the content that populates the UI 400, for example to help ensure that only online stores 138 that are more trustworthy or have higher reputation (e.g., as indicated by the online store 138 having been operation for a minimum length of time, having a minimum amount of sales, or having a minimum number of registered customers, etc.) are able to contribute content to the UI 400.

In the examples described above, the UI 400 displays viewable slots 410 only for online stores 138 having an association with the customer (e.g., online stores 138 that the customer has opted to receive updates from). In other examples, the e-commerce platform 100 may identify (e.g., via the UI content generator 300), based on the customer's recent online activity and/or characteristic of the customer, another online store 138 (e.g., another online store selling products similar to those recently searched by the customer) that the customer does not currently have an association with and may include a viewable slot 410 assigned to that other online store 138 in the UI 400 for the customer.

In some examples, the e-commerce platform 100 may manage (e.g., via the UI content generator 300) how content is provided to UIs 400 across multiple customers. As mentioned above, a given data object 310 associated with a given online store 138 may contain content that is more exclusive (e.g., related to a product having a limited number of units available). It may not be an efficient use of computing resources to provide such exclusive content to all customers associated with the given online store 138, because the availability of the associated product is much smaller than the number of customers who might wish to purchase the product. Instead, the e-commerce platform 100 may identify, from all customers having an association with the given online store 138, a subset of customers to whom the exclusive content of the given data object 310 should be displayed first. For example, some customers may have purchasing habits that identify them as priority customers (e.g., frequently making large purchases, or more likely to purchase new or exclusive products) or some customers may have subscribed to the e-commerce platform 100 to receive exclusive content first. In another example, some customers may have indicated in their customer profiles 160 that they have selected to opt out of receiving certain types of content (e.g., content associated with certain product categories or associated with certain online stores 138). The e-commerce platform 100 may rank the customers associated with the given online store 138 according to a customer ranking, for example based on the priority level, subscription level and/or opt-out selection of the customers. The e-commerce platform 100 may then provide the data object 310 with the exclusive content to be displayed in UIs 400 only for the highest ranked customers.

The e-commerce platform 100 may additionally define the number of highest ranked customers to whom the exclusive content is displayed. For example, the number of highest ranked customers to whom the exclusive content is displayed may be proportional to the availability of the product associated with the exclusive content (e.g., if there are only 40 units of the product, then the associated exclusive content may be provided to UIs 400 of only 40 customers, or 80 customers depending on the expected conversion rate).

In some examples, the e-commerce platform 100 may allow the exclusive content to be displayed to a greater number of customers after a defined period of time. For example, after the exclusive content is available to be displayed to the highest ranked customers for two days, the content may be considered no longer exclusive and may be provided to be displayed to all customers associated with the given store 138. In another example, after the exclusive content has been displayed to the defined number of highest ranked customers for two days and there remains available product, the e-commerce platform 100 may define an additional number of next highest ranked customer to whom the exclusive content is displayed. This process may continue with defined numbers of progressively lower-ranked customers until there is no more product available associated with the exclusive content.

In various examples, the present disclosure has described systems and methods enabling generation and provision of content to be displayed to a customer in a UI. The disclosed methods and systems enable an e-commerce platform to act as a trusted intermediary that manages and mediates the flow of content to the customer. In particular, the disclosed methods and systems help to ensure fairness in the content displayed to the customer, regardless of how much or how fast content is generated by an online store. Further, in some examples the disclosed methods and systems enable the e-commerce platform to automatically generate content for an online store, by monitoring and extracting data from the store's operational data.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A system comprising:
a processing unit configured to execute instructions to cause the system to:
for each given online store, from a defined plurality of online stores associated with a customer:
obtain a set of data objects associated with the given online store containing displayable content; and
select one data object, from the set of data objects, to display in a given viewable slot assigned to the given online store;
determine a ranking for a plurality of viewable slots based on one or more slot ranking criteria including a customer-specific slot ranking criterion, wherein each of the plurality of online stores is assigned a defined number of one or more viewable slots; and
provide the selected data objects for the plurality of viewable slots to an electronic device associated with the customer, to cause the electronic device to display the selected data objects in the plurality of viewable slots in a user interface according to the ranking.

2. The system of claim 1, wherein, for each given online store, the selected data object is selected based on a ranking of the set of data objects according to one or more content ranking criteria including a customer-specific content ranking criterion.

3. The system of claim 1, wherein each of the plurality of online stores is assigned a respective one viewable slot.

4. The system of claim 1, wherein the processing unit is configured to execute instructions to cause the system to create at least one data object in the set of data objects associated with the given online store by:
monitoring operational data associated with the given online store to detect a trigger event;
responsive to detecting the trigger event, extracting product data associated with the trigger event; and
formatting the product data into displayable content to create a new data object in the set of data objects.

5. The system of claim 4, wherein the trigger event includes one of:
addition of a new product page;
addition of a new option or a new category associated with existing product data;
a defined change in existing product data;
a defined change in existing product pricing data; or
a defined change in existing product availability data.

6. The system of claim 4, wherein extracting the product data comprises:
extracting product image data, product description data, product identification data, and product price data;
and wherein formatting the product data comprises:
converting the product image data into a thumbnail format and resolution displayable in the viewable slot;
combining the product description data, product identification data and product price data into a set of text data; and
storing the converted image data and the set of text data as the displayable content of the new data object.

7. The system of claim 4, wherein the processing unit is configured to execute instructions to cause the system to access data associated with the given online store via an application programming interface (API) installed with the given online store, wherein the API enables monitoring of the operational data and extracting of the product data.

8. The system of claim 1, wherein the one or more content ranking criteria includes at least one of:
previous selection of each data object for display in the viewable slot;
previous display of each data object in the user interface;
recency of each data object;
exclusivity of each data object;
time-sensitivity of each data object; or
an engagement score computed for each data object;
and wherein the customer-specific content ranking criterion is one of:
an activity relevancy metric computed for each data object with respect to recent online activity associated with the customer; or
a characteristic relevancy metric computed for each data object with respect to a characteristic identified from a profile associated with the customer.

9. The system of claim 8, wherein the activity relevancy metric is computed by:
obtaining data representing recent online activity associated with the customer;
identifying, from the data, recent online activity associated with a given product; and
computing the activity relevancy metric for each data object by computing a correlation between the given product and the displayable content of each respective data object.

10. The system of claim 1, wherein the one or more slot ranking criteria includes at least one of:
recency of the respective selected data object for each respective viewable slot;
a content engagement score computed for the respective selected data object for each respective viewable slot; or
a store engagement score computed for the respective online store assigned to each respective viewable slot;
and wherein the customer-specific slot ranking criterion is one of:
an activity relevancy metric computed for the respective online store assigned to each respective viewable slot, with respect to recent online activity associated with the customer; or
a store relevancy metric computed for the respective online store assigned to each respective viewable slot, with respect to a characteristic identified from a profile associated with the customer.

11. The system of claim 10, wherein the activity relevancy metric is computed by:
obtaining data representing recent online activity associated with the customer;
identifying, from the data, recent online activity associated with each respective online store; and
computing the activity relevancy metric for each respective online store by computing a weighted sum representing the recent online activity associated with each respective online store, wherein different activity types are weighted by different defined weight values.

12. The system of claim 1, wherein the electronic device is caused to display the user interface by displaying the plurality of viewable slots in the user device according to the ranking, and by displaying the respective selected data object in each respective viewable slot in the user interface.

13. A method, comprising:
for each given online store, from a defined plurality of online stores associated with a customer:
obtaining a set of data objects associated with the given online store containing displayable content; and
selecting one data object, from the set of data objects, to display in a given viewable slot assigned to the given online store;
determining a ranking for a plurality of viewable slots based on one or more slot ranking criteria including a customer-specific slot ranking criterion, wherein each of the plurality of online stores is assigned a defined number of one or more viewable slots; and
providing the selected data objects for the plurality of viewable slots to an electronic device associated with the customer, to cause the electronic device to display the selected data objects in the plurality of viewable slots in a user interface according to the ranking.

14. The method of claim 13, wherein, for each given online store, the selected data object is selected based on a ranking of the set of data objects according to one or more content ranking criteria including a customer-specific content ranking criterion.

15. The method of claim 13, further comprising creating at least one data object in the set of data objects associated with the given online store by:
monitoring operational data associated with the given online store to detect a trigger event;
responsive to detecting the trigger event, extracting product data associated with the trigger event; and
formatting the product data into displayable content to create a new data object in the set of data objects.

16. The method of claim 15, wherein extracting the product data comprises:
extracting product image data, product description data, product identification data, and product price data;
and wherein formatting the product data comprises:
converting the product image data into a thumbnail format and resolution displayable in the viewable slot;
combining the product description data, product identification data and product price data into a set of text data; and
storing the converted image data and the set of text data as the displayable content of the new data object.

17. The method of claim 15, wherein data associated with the given online store is accessed via an application programming interface (API) installed with the given online store, wherein the API enables monitoring of the operational data and extracting of the product data.

18. The method of claim 13, wherein the one or more content ranking criteria includes at least one of:
previous selection of each data object for display in the viewable slot;
previous display of each data object in the user interface;
recency of each data object;
exclusivity of each data object;
time-sensitivity of each data object; or
an engagement score computed for each data object;
and wherein the customer-specific content ranking criterion is one of:
an activity relevancy metric computed for each data object with respect to recent online activity associated with the customer; or
a characteristic relevancy metric computed for each data object with respect to a characteristic identified from a profile associated with the customer.

19. The method of claim 13, wherein the one or more slot ranking criteria includes at least one of:
recency of the respective selected data object for each respective viewable slot;
a content engagement score computed for the respective selected data object for each respective viewable slot; or
a store engagement score computed for the respective online store assigned to each respective viewable slot;
and wherein the customer-specific slot ranking criterion is one of:
an activity relevancy metric computed for the respective online store assigned to each respective viewable slot, with respect to recent online activity associated with the customer; or
a store relevancy metric computed for the respective online store assigned to each respective viewable slot, with respect to a characteristic identified from a profile associated with the customer.

20. A computer readable medium having instructions encoded thereon, wherein the instructions, when executed by a computing system, cause the computing system to:
for each given online store, from a defined plurality of online stores associated with a customer:
obtain a set of data objects associated with the given online store containing displayable content; and
select one data object, from the set of data objects, to display in a given viewable slot assigned to the given online store;
determine a ranking for a plurality of viewable slots based on one or more slot ranking criteria including a customer-specific slot ranking criterion, wherein each of the plurality of online stores is assigned a defined number of one or more viewable slots; and
provide the selected data objects for the plurality of viewable slots to an electronic device associated with the customer, to cause the electronic device to display the selected data objects in the plurality of viewable slots in a user interface according to the ranking.
